(19) United States
(12) Patent Application Publication
(10) Pub. No.: US 2015/0205937 A1
(43) Pub. Date: Jul. 23, 2015

(54) EVIDENCE-BASED PERSONALIZED, DIABETES SELF-CARE SYSTEM AND METHOD

(71) Applicants: Nelson Byron HAZELTINE, Chapin, SC (US); Stephen C. DUCK, Wilmette, IL (US)

(72) Inventors: Nelson Byron HAZELTINE, Chapin, SC (US); Stephen C. DUCK, Wilmette, IL (US)

(21) Appl. No.: 14/590,565

(22) Filed: Jan. 6, 2015

Related U.S. Application Data
(63) Continuation-in-part of application No. 13/914,077, filed on Jun. 10, 2013.
Application No. 13/914,077 is a continuation-in-part of application No. 13/914,032, filed on Jun. 10, 2013.
(60) Provisional application No. 61/658,357, filed on Jun. 11, 2012.
(60) Provisional application No. 61/658,357, filed on Jun. 11, 2012.
(60) Provisional application No. 61/966,183, filed on Jan. 21, 2014.

(51) Int. Cl. G06F 19/00; G09B 19/00

(52) U.S. Cl. CPC G06F 19/3487; G09B 19/0092

(57) ABSTRACT

A personal, evidence-based, self-care information system for the management of diabetes, executing on a computer, receiving data input from a user, processing the data, and outputting results to the user, including a settings module; a glucose module; and a patterns module. A mobile device for the management of diabetes, including a memory, a processor, an input device, an output device, and a computer program executing on the processor, the computer program including a settings module, a glucose module, and a patterns module, and the glucose module receiving blood glucose measurement data input from a user through the input device, the patterns module analyzing the blood glucose measurement data in real time and outputting results of the analysis of blood glucose measurement data to the user. A computer-based method for the management of diabetes, receiving data input from a user, processing the data, and outputting results to the user, having the steps of inputting a target glucose range for the user; inputting a blood glucose measurement; inputting an event associated with the glucose measurement; and outputting information to the user.

The present patent application claims the benefit of previously-filed provisional application Ser. No. 61/658,357, filed Jun. 11, 2012, as provided in 35 USC §119(e) and 37 CFR §1.78(a) and of previously-filed provisional application Ser. No. 61/966,183, filed Jan. 21, 2014. The present patent application is a continuation-in-part of previously filed application Ser. No. 13/914,032, filed Jun. 10, 2013 and a continuation-in-part of previously filed application Ser. No. 13/914,077, filed Jun. 10, 2013.

### BACKGROUND OF THE INVENTION

Diabetes has 3000 years of documented history from the first symptoms observed in 1500 B.C. and naming of the disease in 250 B.C. Gradual advancements in diagnosis, technologies and identification of the pancreas and science of its pathophysiology took centuries, most of which occurred in the last two centuries, specifically over the past fifty years.

In the past decade, the variations of diabetes in individuals were recognized that demanded personalized care to improve and achieve one's best health outcomes. Tools to capture, analyze and present personal data are needed. These tools ought to better focus one's pathway with diabetes. However, no tools or system featuring multidimensional data are available to prospectively plan or manage one's individual diabetes outcomes.

Recent advancements in smart phone and glucose monitoring technologies, e.g., blood glucose meters and continuous glucose monitoring devices, provided Choices & Patterns with the opportunity to integrate these technologies and to create a tool and system with multi-dimensional data so as to guide individualized pattern identification and management, beyond the “linear” data tabulation, commonplace in the diabetes market to date.

Individuals/families with diabetes exclusively manage their own health 98% of the time. The rest is spent interacting with their healthcare delivery “team.” Of the over 8700 hours in a year, only about 3-6 hours are spent with their medical providers in order to manage diabetes. The requisite “every 3 month” visit too often lasts only 30 minutes. Furthermore, only 5-10% of adults with diabetes receive care and education from a Board-certified Endocrinology team. The remaining are cared for by Primary Care or Internal Medicine teams, most of whom lack both the time and specific knowledge to adequately support those with diabetes mellitus.

Consequently, individuals/families must learn to become independent regarding self-management in order to succeed. At the core of this “success”, will be a secure understanding of the “forces” that shape their moment-to-moment glucose control coupled with positive feedback on how to manipulate those “forces” throughout their own life's, varied activities. Attainment of such “success” proved to be a way to maximize personal responsibility and accountability for one's health outcomes.

Noteworthy among those living with diabetes mellitus is the reality that “there is never a vacation” from the pressures and concerns. Fatigue, depression, exhaustion, and denial are common responses experienced by persons diagnosed with diabetes. Given these additional challenges among persons with diabetes, the healthcare delivery system too often fails to support them over the long haul

Beyond these interpersonal concerns that negatively impact the support of persons with diabetes [PWD], larger, structural impediments exist. The current health care delivery system is compromised due to: 1) failure to maintain awareness of the patients' evolving socioeconomic and psychological and family structural issues; 2) failure to have access to accurate data, properly recorded, in sufficient detail; 3) failure to insure appropriate, consistent follow-up; 4) failure to prospectively store the full historical record of one's disease control; 5) failure to collect specific diagnostic criteria for proper definition/characterization of the specific “cause” for diabetes mellitus; and 6) failure to provide correct information requisite to maximize control.

To date only minimal improvements in patient self-management and health outcomes using current products/services are reported in professional journals. No products or programs in the diabetes information management provide comprehensive personalized information of an individual's self management and outcomes patterns. Nor do the retrospective checklist formats of today's Electronic Medical Records weave a personal historical narrative or support prospective planning and pattern management

Our innovations are developed to provide the best solution for the problems of personal control of diabetes mellitus. These “problems” include but are not limited to the coordinating of the complex interactions among food, exercise and medications, and stress/illness in order to maximize the time spent within a prescribed blood glucose target range. This challenge exists against the background of the acute care practice model of disease-oriented, medical practice in today's healthcare delivery system.

Control of blood glucose concentrations within our bodies is essential for maintenance of good health. The human body uses both the intake of carbohydrates and proteins as well as the body's own internal “balancing systems” to provide the necessary glucose for all our daily activities.

The internal balance of normal glucose values is a well-orchestrated symphony of metabolic and hormonal systems to maintain the human glucose level in the range of 60 mg/dl up to 200 mg/dl. This system is active every moment of the day yet requires quite different “forces” to achieve the goal.

While several hormones exist in our bodies that are capable of elevating our blood glucose, only one hormone exists to lower glucose: insulin. The interrelationship of glucose levels and insulin levels is quite complex, but can be rather well simplified to the visual image of a “teeter-totter” or “servo-mechanism.” If insulin is down, glucose goes up; if insulin is up, glucose goes down. Together this dance occurs in perfect synchrony in states of wellness. This can be visualized in FIG. 5: eating meals initially elevates glucose levels that in turn provoke elevations in insulin, resulting in return to normal glucose levels which allow for the return to normal insulin levels.

Diabetes mellitus is a global description of many distinct diseases that all have in common an irreparable breach in the normal synchrony. In a useful but oversimplified definition, all persons with diabetes are not able to produce enough insulin to control their glucose levels. The resultant condition is “high blood glucose.” The requisite treatment is to provide “enough” insulin.

In order to provide “enough” insulin, FIG. 5 gives a clue as to the dual nature of the challenge. First, a large amount of insulin must be released quickly whenever food is consumed. This large amount of insulin must then quickly “disappear” as the food is necessarily processed and stored. For most humans, eating a “typical” meal, this digestive process lasts around 2-2.5 hours. Digestion can certainly be prolonged by meal content and co-existent disease.

Second, a low, steady amount of insulin is required when no food is at hand. These periods occur in all of us during “sleep” or other voluntary times of fasting or merely when digestion is complete. This low, steady insulin has a time action that is considered as “slow” or “lumbering” compared to that for mealtimes.

For those with Type 1 diabetes mellitus [and eventually almost all with Type 2 diabetes mellitus], conventional multiple daily dose [MDD] therapy is represented in FIG. 6. As shown in FIG. 6, in an earnest attempt to “copy” or “mirror” the normal insulin profile [in gray], multiple discrete doses of rapid acting [RA] insulin are provided at meal times and long-acting insulin [Glargine or Detemir] is provided daily for those insulin requirements not associated with meal-time glucose control.

An evolving, contemporary mode of insulin delivery utilizes an electro-mechanical insulin syringe delivery device. This is commonly referred to as an “insulin pump.” The overall concept for insulin delivery is identical: “bolus” delivery for food consumption and “basal” for necessary insulin requirements not impacted by eating.

All current methods of insulin therapy involve injection/infusion of artificial insulin under the skin. Technically, this means infusion into the subcutaneous tissue of the body. For those knowledgeable on the path of delivery of insulin from the pancreas to the liver and beyond that is “nature's way”, quickly understand that all contemporary delivery of insulin is not “natural” and therefore never able to mimic the body's ideal. Yet another hurdle is erected to good control.

That notwithstanding, the question remains: how much insulin should I take? This quickly devolves into two challenges: how much for food and how much for the rest of the day?

Solution of these two existential questions is the bane of those coping with diabetes mellitus. Until the “bionic cure” is accomplished, the hundreds of millions of persons with diabetes mellitus must find their unique and evolving answers.

Currently the “solutions” to these questions require pattern recognition of their variables that impact the interplay of Insulin, Glucose consumption, and Exercise. Can the interplay of these variables be practically explained? Globally, they can. But like an explorer, the answers have to be carefully culled from a host of “clutter.”

Each PWD must become his/her own detective. What are the solutions to the riddles? Pattern management begins with “solving” 3 riddles:

One unit of rapid-acting [bolus] insulin will allow me to eat how many [X] grams of carbohydrate?

One unit of rapid acting insulin will lower my current glucose by how many [Y] mg/dl?

The increased/decreased activity for the next 4 hours will require me to alter by [Z] percent my rapid-acting insulin dose and possibly my long acting insulin dose?

Once tentative solutions to the above 3 riddles are formulated, the observer must constantly monitor for deviations. The observer must also determine if the deviations follow a predictable pattern [that can be recognized]. Such monitoring is relentless and understandably mind-numbing. This latter point is apparent to the PWD and to their health care team.

An adjunct to assist the PWD is needed to provide active feedback during the course of daily self-care and monitoring. A visual mnemonic is urgently needed that informs and alerts and suggests explanations for not only the good but also the undesired patterns of glucose control.

None exists. The present patent application provides this solution.

Persons with diabetes (PWD) find it challenging to understand the relationship between food, exercise or medications and subsequent blood glucose readings. As a result, adverse events continue, accumulate, and eventually require medical intervention; and were preventable if the PWD had the understanding to self-manage.

PWDs often make the mistake of “defining the problem” based solely on the glucose reading at any point in time. In truth, the food, exercise, medication and “activity” prior to that given blood glucose reading are the “problem” that determined the blood glucose result.

This patent application is about explicitly and visually showing the relationship among time/amounts of medications, food and exercise and blood glucose readings at all points in time. Showing this relationship visually (called a relationship infographic or Impact Chart) will enhance the understanding of the interactions and impact on glucose readings by PWDs. Understanding the interrelationships, interactions and impact of food, medications and exercise (as well as other factors such as stress, infection, illness, injury and more) will empower the PWD to more successfully stay within his/her personally selected blood glucose target range. This understanding will promote early problem identification that should alter self-treatment and achieve one's personal best health.

### SUMMARY OF THE INVENTION

A focus for the present invention is on diabetes as a chronic, progressive disease that is not a stand-alone disease but is accompanied by complex, chronic, co-existing diseases/conditions. Uncontrolled diabetes is associated with damaging, systemic complications to all body organs including the brain that research is finding leads to dementia and Alzheimers Disease. Multiple management strategies and adjustments are required over time to address the complexity of diabetes for each individual at different times of physiological and biological changes with aging.

Systematic reporting, tracking, monitoring and documentation of outcomes patterns with immediate visual feedback offer the opportunity to practice anticipatory, preventive care. The opportunity is to prospectively plan and manage to become or remain healthy, to achieve and maintain personal best diabetes and health patterns/outcomes. The capability to see and gain insight using diverse visual methods as to where changes or adjustments in patterns need to be made helps people with diabetes to stay on a prescribed health path. Rather than a checklist record and retrospective analysis used in today's acute care practice model, the System tool weaves a historical narrative across time to clearly visualize the individual's unique variations and manifestation of diabetes in the path the PWD is traveling. An ongoing historical narrative mitigates the need for healthcare professionals to synthesize episodic data and information that lacks connections and continuity at point-of-service. Quality of both self-care and professional management is improved as different professionals with differing levels of knowledge and experience are supported with the continuity of the individual's personal historical narrative that can be summarized and accessed in selected time periods. The value is in ongoing, on-time individual education as changes in diabetes treatment and management are needed. Changes with aging across the life span are necessary when living with diabetes as a progressive disease.

Improved capability in self-care and professional management to capture meaningful, detailed personal data/information is made a reality through the easy-to-use, real-time tool and system to systematically support personal reporting, tracking, monitoring, documenting and visualizing personal management and outcomes patterns.

There is a need for changes or adjustments in the core elements of daily management, i.e., food, exercise, medications and their complex interrelationships and interactions that can be seen and more easily interpreted. Daily management is made up of the timing and coordination of choices, habits and behaviors in food, exercise/activities and medications that in their combined, complex interaction influence blood glucose patterns. Choices & Patterns' tool and system (smart phone application and impact chart) and the attendant supporting services are the next evolutionary advancement in the history of diabetes to identify, treat and manage long-term individual variations and manifestation of diabetes within the context of diabetes as a progressive disease.

The present invention is a personal evidence-based, self-care information system and method to better ensure competent personal management, outcomes and health status across time for progressive chronic diseases, beginning with diabetes. Early problem identification triggers the system to detect and collect detailed data/information to immediately synthesize, correlate and analyze to give information feedback in multiple visual formats. The purpose is to prompt and guide quick action in real-time or near real-time to resolve adverse events for out-of-range blood glucose values (outliers) that with frequency or left unresolved lead to equally rapid onset of complications in all diabetes types. The system design assists people with diabetes to stay on course with a prescribed health plan and learn with each adverse event the precipitating factors that led to blood glucose outliers in order to prevent patterns of repeating the same in the future.

The invention is based on a whole life context and approach. Daily diabetes management is embedded within one's usual daily living routine rather than fitting one's life into a rigid diabetes regimen. Central to the emerging paradigm shift is the method and process of real-time, systematic data/information reporting, tracking and monitoring designed to achieve evidence-based self-care and beneficial, long-term outcomes. Evidence-based self-care informs and guides anticipating and prospectively planning management to achieve long-term, best personal self-management strategies to become or remain healthy. The concept of health is always about the future; becoming or remaining healthy.

The importance of evidence-based population wide self-care and outcomes hold promise to inform and enhance evidence-based medical care.

The four core modules that make up the present invention are Settings, Glucose, Patterns and Training (TIPS). The modules begin a growing comprehensive system, of which the four modules are the critical management core, to integrate future modules offering expanding data/information to manage conditions associated with diabetes, e.g., depression, hyperlipidemia, hypertension, systemic complications, obesity, cancer and more, with additional modules.

The four core management modules assist the user to better control and achieve competent daily self-management. More modules can be added depending on the information needs of individuals and families. A prospective, non-limiting example is a module for depression and mental health, common to long-term diabetes management when individuals become tired of daily management. To relieve the fatigue and boredom with daily management, the present invention establishes, monitors and conducts long-term tracking of patterns and recommends, dependent on the individual's personal patterns, the frequency of reporting their daily self-management regimen to detect the need for changes in medication, diet or activity/exercise to obviate fatigue, stay on course and maintain overall health. The innovation and improvement over previous and existing products and services that are episodic, disease-oriented and from the medical perspective are: 1) systematic patient reporting, documenting, monitoring and tracking of the patient's long-term response patterns, 2) compliance with management protocols, 3) feedback in patterns on habits, lifestyle choices and behaviors, 4) prospective planning and management to become or remain healthy, 5) manage for personal best outcomes rather than leaving outcomes to chance, 6) educating via the training (TIPS) module to guide the user to learn at one's personal pace about diabetes and monitor diabetes as a progressive disease over time to make adjustments where needed to stay on course with prescribed target health goals.

Incentives to continue to use the present invention over the long term of living with diabetes can be added.

The present invention overcomes the limitations of current diagnosis, intervention and information/care methods and processes to quickly provide real-time, in-depth data entry and analysis in an average time of about 15 to 20 seconds for the experienced user. Entering normal blood glucose values takes on average about 3 seconds as there is no further data entry necessary. There are no systematic, long-term solutions in place today that account for the fact that diabetes is a progressive disease across the lifespan. Physiological and biological stages of growth, development and aging and their associated changes within the context of one's life with diabetes, require monitoring and on-time adjustments in management strategies to achieve an individual's best quality of life and prevent, delay, mitigate or reverse complications and co-morbid diseases.

An objective and feature of the present invention is to enable an individual to become more independent through ongoing, on-time monitoring of progress or destabilization of one's diabetes and health status. A feature is providing education at the time one needs information to manage blood glucose outliers, problems or adverse events with prompts to guide quick response and return to a prescribed blood glucose target range. A benefit of frequent use of the application is to help establish a daily routine to make life easier, eliminating the need to constantly think through every management element. Lack of a daily routine may also lead to mindless management, i.e., inattention until one's becomes ill or experiences onset of complications of body systems.

Achieving gradually increasing knowledge and skills at one's personal pace at the point in time when needed and is “top of mind” promotes competent self-management and replaces waiting to be told what to do between quarterly doctor visits when it is too late to accurately recall important details. That is: 1) learn to spot and identify outliers, problems or adverse events early, and, 2) reason through and act promptly to resolve outliers, problems or adverse events as a result of understanding and being able to correctly apply appropriate management protocols.

The reporting and data entry process in the present invention provides entering a timeframe of the blood glucose, e.g., before/after meals, daily activities, exercise, and medications. When outliers of high or low blood glucose values or wide swings between high and low values are identified, the associated in-depth reporting automatically goes to the appropriate pathway to enter symptoms, causes, treatment, results and response time, i.e., the time it took to return to a prescribed blood glucose target range. The normal, high and low pathways are preferably color coded so that the individual knows he/she is entering data in the appropriate path. The time-stamped, detailed data/information reflects impact on diabetes and overall health outcome patterns across time. Patterns information is designed to provide several presentation formats to make personal interpretation of management and related outcomes easier, helping the individual/family to become more independent in decision-making and making relevant changes in daily management. Daily management becomes easier through forming a daily routine of the right habits, lifestyle choices and behaviors, all of which are confirmed or highlighted in patterns to see where success is achieved or changes, improvements or adjustments should be made.

The cumulative data/information is analyzed to reveal patterns to educate, guide and anticipate future health events based on habits, lifestyle choices and behaviors. In the case of problems, blood glucose outliers and adverse events, the individual is guided through a time stamped process of entering relevant data that integrates and analyzes total daily activities of meals/snacks, activity, exercise/sports and medications to reveal where errors or failures in management exist to competently coordinate these interrelated elements. The analyzed data is reflected in the Patterns Module to achieve pattern recognition that is used to prospectively manage for best personal outcomes in the future. The method and process in the present invention through data collection and immediate analyses produces personalized visual patterns in several different data presentation formats in the Patterns Module to address user preferences for reviewing and evaluating self-management, habits, lifestyle choices and behaviors. The method and processes are designed to reflect where good management is achieved as revealed by outcomes and where changes in habits, choices and behaviors are indicated.

The ultimate information from the invention is to guide the individual and the healthcare team to improve management and outcomes that results in improved metabolic control. The summarized information that determines the category of metabolic control resides in the Metabolic Control section in the Patterns Module The critical elements in the Metabolic Control section are: 1) the number of blood glucose readings, 2) the number of high and low outside an individual's prescribed target rang 3) ketones associated with high blood glucose values, 4) wrong medication doses that caused high or low blood glucose values 5) number of blood glucose values before meals of 70-100

6) number of blood glucose values at 1 and/or 2 hrs after meals at least under 180
7) number of blood glucose values 80 to 150 at bedtime 8) number of blood glucose values of 70 to 150 during the night. The foregoing are combined with A1c values every 3, 6, 9 or 12 months, extra MD office visits, Emergency Room visits and/or hospitalizations for adverse events. Combined all these elements are determinants for categories of good, fair, poor or very poor metabolic control. The Metabolic Control section provides a comprehensive picture of the individual's competence and skill in self-management, level of understanding and application of knowledge to self-management as well as collabortion with a healthcare team who may also have deficits in knowledge and service. The categories of metabolic control are a guide to the need for frequency of ongoing monitoring, continuing close observation and care by the healthcare team and education needs. The present invention specifically supports anticipatory and preventive care, prospective planning and management to help an individual/family to manage to remain or become healthy, i.e., maintain or achieve one's personal best health outcomes.

A feature of the present invention, as a personal diabetes management program, is to increase a perception of control, health literacy, confidence and independence in learning how to achieve competent self-management. This is important because diabetes is a progressive disease and usually a life-long condition that evolves through physiological and biological stages of growth/development and/or the aging process depending on the age at diagnosis Focus of the personal diabetes management program is on a daily living routine that encompasses changing, improving or maintaining productive lifestyle choices, habits, behaviors and competent, skilled self-management strategies to make daily diabetes management easier and achieve personal best health outcomes.

A feature of the present invention is the use of smart devices, e.g., iPhone, iPod/iTouch, Droid, etc. The mobile smart device is held close to one's person and used as an extension of the hands and brain making it the best communication and information exchange tool to collect, analyze and produce immediate actionable information. Smart devices offer the platform for embedded intelligence in health information applications. It is expected that easier and better interpretation of personal information and health patterns leads to self-knowledge, understanding and more consistent application of knowledge to daily health and life management. Control over quality of life, productivity and energy through life stages and the aging process is advanced.

### BRIEF DESCRIPTION OF DRAWINGS

FIG. 1 is a graphic of one embodiment of the invention displayed on a smart device.

FIG. 2 is a block diagram of one embodiment of the invention, showing the interrelationship of the modules.

FIG. 3 is a flowchart of a method embodying the present invention.

FIG. 4 is a flowchart of a method embodying the present invention.

FIG. 5 is a graphic showing the relation of plasma glucose and plasma free insulin over time.

FIG. 6 is a graphic showing the effect of administering multiple discrete doses of rapid acting [RA] insulin at meal times and long-acting insulin (Glargine or Detemir) daily for those insulin requirements not associated with meal-time glucose control.

FIG. 7 is a flowchart showing a method of collecting and displaying information.

FIG. 8 is a graphic showing a first patterns output.

FIG. 9 is a graphic showing a second patterns output.

FIG. 10 is a graphic showing a third patterns output.

FIG. 11 is a graphic showing a third patterns output.

FIG. 12 is a graphic showing a third patterns output.

FIG. 13 is a graphic showing a fourth patterns output.

### DETAILED DESCRIPTION OF THE PREFERRED EMBODIMENT

The primary goal of the present invention is to support individuals/families to take control of daily diabetes management fitting into an overall daily living routine incorporating general health habits, choices and behaviors. Special focus is placed on developing the right habits, choices and behaviors that result in an individual's capability to competently manage to achieve personal best diabetes and health outcomes. The individual is his or her own standard for evaluating overall health status, progress or destabilization of health. Individual outcomes are also measured against established national standards of care and expected outcomes embedded in the application data collection and analysis processes to evaluate the narrowness or width of similarity or difference between individual outcomes and the standards of care.

The present invention design, methodology and value in the market provides a real-time, streamlined process and system of data entry, analyses and immediate information feedback to prompt not only quick response/action to identified problems, outliers and adverse events in real-time but also documentation of the interrelationships among the daily core management elements; meals/snacks, activity/exercise and medication and their effect on blood glucose values. Methods of analyzed data/information presentation in the Patterns Module make interpretation easier to see the results of self-management; areas of good management and where changes need to be made to achieve personal best outcomes.

The present invention is designed to be used by people with all types of diabetes; Types 1, 1.5, 2, Gestational, MODY (Maturity Onset of Diabetes in Youth) and LADA (Latent Autoimmune Diabetes in Adults). In addition to the initial four modules; Settings, Glucose, Patterns and Training (TIPS) Modules, future modules are planned to address specific needs of people with associated conditions that must be managed with diabetes to stay on course and enjoy a desired quality of life with the foundation of a stable health status. Individuals with diabetes, as a progressive disease, benefit from prospective planning and management to become or remain healthy tomorrow and into the future. The present invention offers individuals/families the hope and control of sustaining personal best diabetes and overall health outcomes over the life span.

The design of the invention is mapped on the total daily activities required for competent self-management of diabetes. Specific focus is on a system and method for detecting daily living habits and choices that contribute to blood glucose outlier patterns that eventually lead to serious systemic complications. The present invention is specifically designed to capture high and low blood glucose patterns and associated information as to frequency, timeframes, symptoms, cause, treatment, results and response time to return to a prescribed blood glucose target range. The target range is personalized and can be set by the individual/family in the Settings Module. Each data point entered is time stamped.

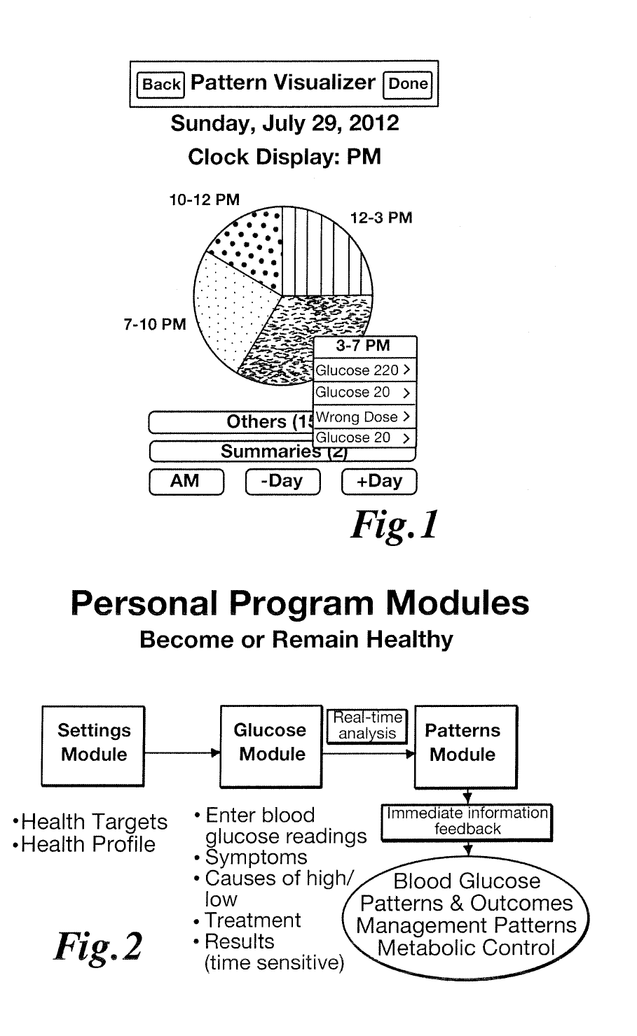

In one embodiment, shown in FIG. 1, the present invention streamlines and structures patient/family reporting on a smart device, e.g., but not limited to, smart phone, to collect data/information related to the three interrelated daily management activities, i.e., food intake, activities/exercise and medication to analyze their effect on blood glucose values. The present invention as a privately controlled, personal information application is designed to analyze and integrate blood glucose values with food intake, medications and exercise in multiple presentation formats including a 24 hour clock (12 hour AM and PM clocks) to demonstrate the results and response patterns of daily management. This information presentation of management results and patterns is a more familiar visual and understandable format than older methods of scatter grams, pie charts and bar graphs. The majority of individuals/families either can't or have difficulty interpreting and transferring information in scatter grams, pie charts and bar graphs to daily management planning, decisions and actions. The 24 hour clock method of data/information presentation is designed to empower and support the patient and family to see and more easily interpret, through immediate information analysis and feedback, personal health patterns, habits, lifestyle choices and behaviors that result in the quality of health outcomes.

Refer to FIG. 2 for the following description.

The Settings Module contains historical baseline clinical data and demographics. The Glucose Module allows the individual/family to report blood glucose readings, e.g., normal, high, low and wide swings between high and low values including in-depth, detailed and meaningful data associated with the readings. Events associated with high, low or wide glucose swings are reported in the Glucose Module, specifically, the time of an event associated with an out-of-range glucose reading, the glucose reading(s), symptoms, possible causes, treatment, results and response time, i.e., the time it took to return to the prescribed blood glucose target range and achieve a stable health status. Examples of an event may be associated with, but are not limited to, intense exercise, too little exercise, sports, illness, infections, trauma, depression or psychological states such as depression. The present invention is designed to spot problems early and identify patterns that need evaluation for possible intervention and education to anticipate and prevent the same event from happening in the future. This is the anticipatory care function in the application. The anticipatory care function sets the stage for prospectively planning the future health pathway to achieve personal best health outcomes rather than leaving outcomes to chance.

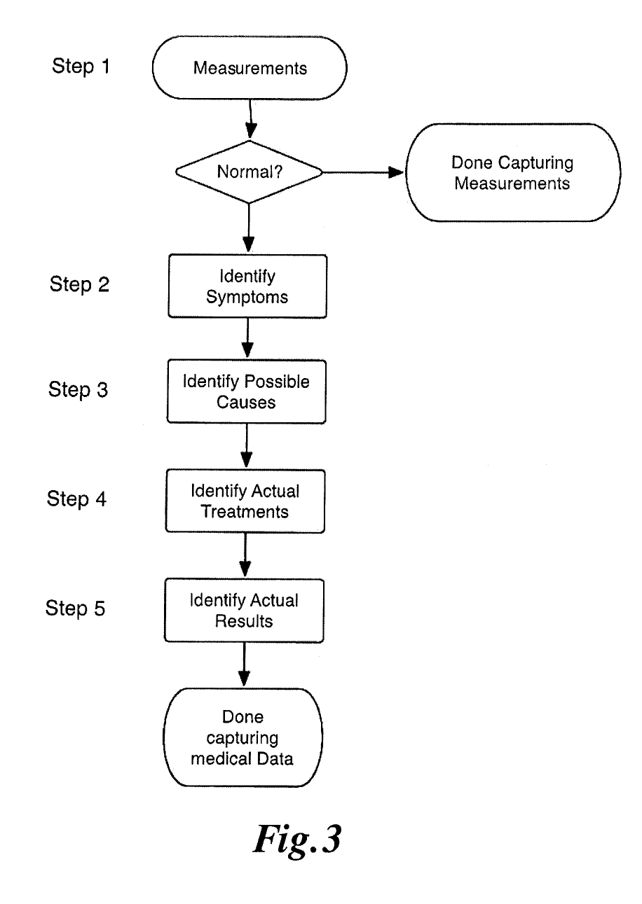

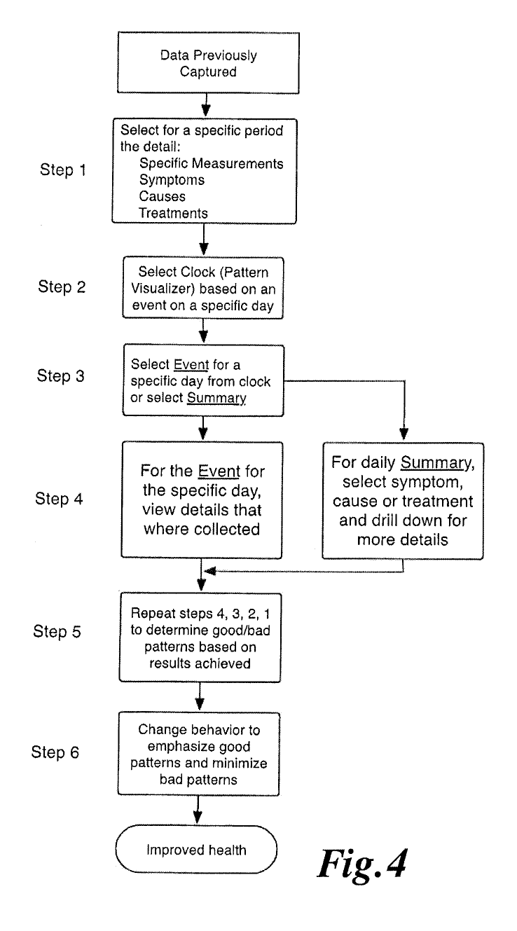

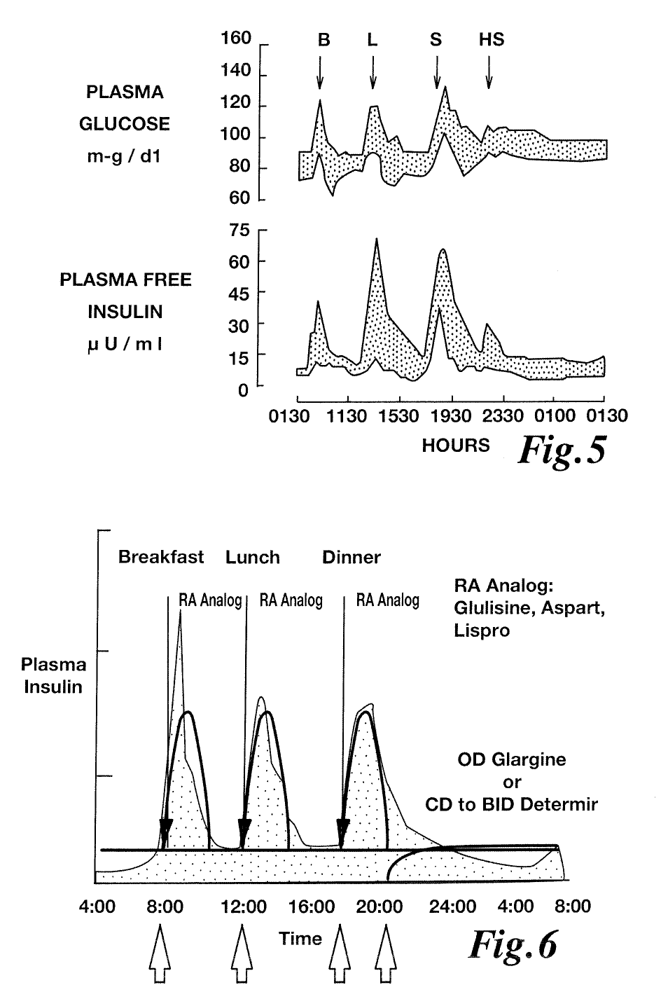

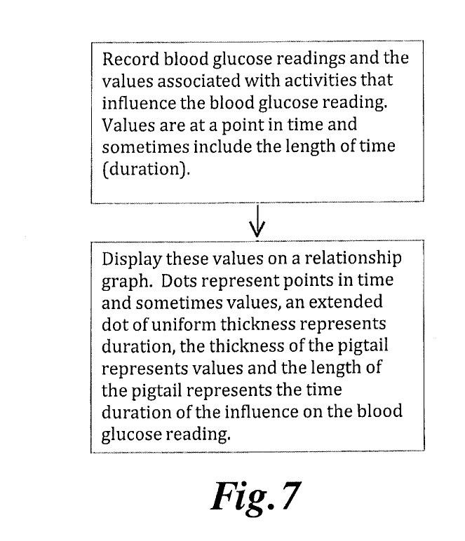

Refer to FIGS. 3 and 4 for the following description.

All data and information in the Settings and Glucose Modules are immediately analyzed and results sent to the Patterns module. Patterns result from analysis of frequent reporting of meals/snacks, activities/exercise and medications to reflect their relationship and effect on blood glucose values and metabolic control. The Training or TIPS Module explains how to use the Modules to assist in achieving competent management.

Detailed data is analyzed and presented in diverse presentation formats in the Patterns Module. Immediate information feedback is accessible upon reporting outliers, problems or an adverse event. The Patterns Module highlights the daily as well as aggregate outcomes resulting from ineffective habits, choices and behaviors. Interpretation of data/information is made easier through visualization of one's patterns in various ways. The individual/family can see when to seek help or where to adjust diet, exercise, medications or a daily routine as needed to achieve blood glucose target range and good metabolic control.

In one embodiment (see FIG. 1), the Patterns Module provides several ways to view the data and corresponding patterns including a pie chart that reports the percentage of time one is in high, low or normal blood glucose levels. Also available is a vertical list of blood glucose readings, time stamped, with a timeframe (before/after meals, daily activities, exercise, medications, bedtime, during sleep and random). One can select to look at 10, 14 and 30 days of blood glucose readings. The eye can quickly scan and see blood glucose trends. An AM and PM clock provides a 24 hour detailed view of blood glucose levels, events, causes, symptoms, treatments and results in each marked time sector. The clock is designed to assist with easier interpretation of data and information the individual/family entered to reflect where best choices, habits and management are yielding the best outcomes and where improvements or changes may be needed to improve management and outcomes.

Method

The Capturing of Data for Analysis

Step 1 Data Collection Specific to Diabetes Management

Blood Glucose Readings and related data: timing of food, activity, exercise and medications, are collected.

If blood glucose readings are within a prescribed target range, also called “normal” for a given individual, then no further data is preferably collected. The assumption is that the individual is managing food, activity, exercise and medications to achieve blood glucose target range and good metabolic control, the latter, if about 85% of the time. If blood glucose readings are not “normal,” the system captures measurements and the timeframes in which they occurred such as before or after meals, snacks, activities, exercise, and medications.

The personal diabetes management program is meter agnostic. Numbers data from all meters on the market can be entered manually or automatically. Although there may be a downside of manually entering numbers due to human error, there are safeguards to collect as accurate information as humanly possible than can be used for effective self-management and communication of data and information to the healthcare team. These are: adequate education and demonstration of use and purpose of the program, immunoassay tests such as the HgbA1c that reflects the level of blood glucose control and thereby determines Metabolic Control. Meter specific uploads directly from a meter to the smart phone are also within the scope of the invention. The scope of the invention also includes data from continuous glucose monitoring (CGM) apparatus. Such data may be transferred from the CGM apparatus via Bluetooth or other transmission protocols.

Blood Glucose Values Outside an Individual's Prescribed Target Range

Step 2. Data Collection Specific to Blood Glucose Outliers, high or low outside the prescribed target range.

In an embodiment, there are two Pathways, color coded to enter outlier blood glucose data. Orange is for high blood glucose outliers and violet for low blood glucose outliers. The color code for normal is blue. The user enters symptoms from a list of common symptoms for each high and low. The user enters “other” if the symptoms experienced are not on one of the lists.

Step 3. Pursuant to the pathway selected by entering a high or low blood glucose value, the individual is asked to identify and enter possible causes to orient one and raise consciousness as to why patterns of adverse events associated with high or low or wide swings in high and low blood glucose values are happening.

Step 4. Following on entering data for symptoms and possible causes, the individual decides to 1) call the doctor or team 2) determine the treatment to perform oneself 3) go to the ER that may be followed by discharge following treatment or hospitalization depending on the individual's stable or unstable status despite treatment.

The actual treatment is entered. If the treatment is for high blood glucose, the treatment data can be entered at the time of treatment.

If the treatment is for low blood glucose, treatment data is entered after returning to a stable state and target range blood glucose values since low blood glucose is always considered an Emergency. The individual doesn't use the system at or during a low blood glucose episode but is encouraged to enter the data after the fact to render the data in the Patterns Module as accurate as possible, for example, that the percentages for normal, high and low are accurate on the first screen in the Patterns Module.

Warnings related to high and low blood glucose values according to national standards of care are placed at critical points of data entry. For example, if a high blood glucose is 300 or above, the individual is advised to test for ketones. For low blood glucose levels an individual is advised that a low blood glucose value is always a medical emergency and should be treated immediately. Data is entered after the fact.

Step 5. Actual Results are entered with blood glucose reading and timeframe so it can be evaluated as to how long and how much treatment was required to return to an individual's prescribed blood glucose target range from a high or low or wide swings between high and low blood glucose values.

Utilizing Captured Data to Visualize Patterns and Better Manage Health Status

Data entered in real-time in the Glucose Module is integrated with historical data from the Health Profiles in the Settings Module. The personal diabetes management program integrates the historical data in Health Profiles with the Glucose Module and sends it immediately to the Patterns Module for immediate information feedback. The value of the immediate feedback is to more easily see, using, without limitation, different visual techniques such as a pie chart, vertical lists of blood glucose readings and associated data and AM and PM clocks, the effect of an individual or family's results from self-management or interaction with the healthcare delivery system, i.e., doctor/team, Emergency Room or Hospital. In some cases the healthcare delivery system may be an Urgent Care, Immediate Care or Outpatient Clinic or Services. The school system may be involved if the child is of school age and a blood glucose outlier and/or an adverse event happens during school hours.

Step 1. The individual/family taps the Patterns Module icon and proceeds to select a specific time period to look at, interpret and evaluate the data in the Patterns Module for a specific blood glucose or for 10, 14 or 30 days to be able to more easily see and interpret trends and patterns resulting from self-management of a daily routine of choices, habits and behaviors that affects diabetes and general health outcomes.

The first screen in the Patterns Module shows the pie chart that has automatically been tracking all blood glucose values entered by the individual or family.

The percentages of normal, high and low blood glucose readings are displayed in the pie chart in percent numbers and color coded: blue is normal, orange is high and low is violet to correlate with the blood glucose data entry pathways in the Glucose Module. This is to help the individual/family to visually follow and understand how to use and see the blood glucose pathways with their associated relevant data and timing: food, activity, exercise and medications. Photo and Audio data may also be accessed in the Patterns Module as a result of entering photos, text or verbal descriptions of food intake.

The first screen, in addition to the pie chart, provides Glucose Reading Detail, Symptoms Detail, Cause Detail, Treatment Detail and Metabolic Control.

The Glucose Reading Detail provides: Date, Time, GUR (Glucose Reading), D (Determination, TF (Time Frame) and CLK (AM and PM Clocks)

The AM and PM Clocks serve to provide a 24 hour view of one's management and results. The Symptoms, Cause and Treatment screens provide Date, Time, Symptoms, Cause or Treatment and the Clock.

Step 2. The Clock when selected presents another method of visualizing patterns including specific outlier event data such as carbs, food (photos, audio), activities, exercise and medications, correlating them with specific blood glucose values. This is to give the individual/family an overall view of the total elements related to a high or low outlier blood glucose value. The goal is easier interpretation through this visual presentation to guide and help see where changes may need to be changed: diet, activity, exercise and/or medication(s), dose, time, type, route.

Specific days can be selected by pressing the + days or − days from a day being displayed.

Step 3. Select an Event for a specific day from the clock to select a Summary. Symptoms, causes, or treatments can be drilled down for more details.

The events and associated data points are collected and passed on to the Pattern Analyzer where they can be displayed.

This results in a closed loop system, i.e., an initial series of measurement events lead to a pattern that, in turn, leads to improvements which leads to another initial series of measurement events.

The invention tailors the individual/family's real time perspective and insight into self-care through data question sets. The invention then immediately analyzes and provides integrated information feedback on the management of the interrelationships of meals/snacks, activity/exercise and medications and their effect on blood glucose values that reflect self-management knowledge, competence and results.

The result is to educate patients/families in real-time with immediate information feedback to augment learning and the best self-management strategies that yield the best results at a personal pace over time; prompt and guide quick response and action to address and resolve health problems, adverse events or incorrect knowledge of management protocols to stay on course, i.e., obviate veering off course. This is designed to teach to anticipate and prevent future problems, adverse events or inaccurate application of management protocols by immediately reflecting results in the Patterns Module. The clock charts are divided into sectors that enable the total data and results for each 24 hour period over 10, 14 and 30 days. Entire data sets, time stamped for each event associated with a timeframe (before/after meals, exercise, medications) and an outlier blood glucose value, including carbs, food intake, activity/exercise, medications causes, treatments, results and response time are used. The clock is designed to help the individual/family to detect patterns more easily.

In an embodiment, the invention displays a graphic that shows the variation of blood glucose levels over time and overlays various events such as carbohydrate intake, exercise, basal insulin administration, and bolus insulin administration. The duration of effect of these events is preferably adjustable by the user. Other events may be included by the user. The effect of stress and illness, e.g., may also be displayed.

Events are of two types: (1) causal events and (2) adverse events. The primary causal events are the administration of bolus insulin, administration of basal insulin, and exercise. Causal events are events that force or drive the blood glucose level (as manifested by the reading of the blood glucose level). Other causal events include, but are not limited to, stress or illness.

Adverse events are events that are a consequence of causal events. Unscheduled doctor visits, times in a hospital, number of out of range conditions per month, etc. described in this document under the heading of metabolic control. The reason adverse events are important is because the PWD needs to eliminate or a least minimize adverse events for better health.

Duration is the length of an event. We have used exercise as example. A PWD can exercise for 1 hour or 2 hours, etc. We show this on the chart as an extended dot that represents duration.

Duration Effect, in our terminology “pigtail,” is the lingering effect of an event on the blood glucose level. This effect is after the Event and usually starts at the end of the Event Duration. For example, the Duration Effect of food starts with the last bite but the PWD may have a meal duration of 30 minutes. As pointed out in this document, the shape of the Duration Effect on the Chart can be linear or vary over time.

The following experiments describe this embodiment.

### Experiment #1

Blood glucose readings were taken at discrete intervals (e.g., by finger pricks). Carbohydrates, bolus insulin, and basal insulin were administered at the times shown in Table 1. The patient exercised moderately for the duration shown in Table 1. The pigtail effect (i.e., duration of effect) of exercise was set to “moderate” (2 hours).

TABLE 1

| | | | | | | Meter BG | | | | | | | |
|---|---|---|---|---|---|---|---|---|---|---|---|---|---|
| Bolus | | Carbs | | Basal | | (finger prick) | | Exercise | | Pigtail effect | | Targets | |
| 4 | 1:00 AM | 50 | 8:00 AM | 17 | 8:00 AM | 203 | 1:00 AM | 1:15 PM | 2:15 AM | Moderate | 2 hours | Low | High |
| 18 | 8:00 AM | 80 | 11:45 AM | 18 | 8:30 PM | 331 | 8:00 AM | | | | | 70 | 80 |
| 15 | 11:45 AM | 90 | 8:30 PM | | | 215 | 11:45 AM | | | | | | |
| 25 | 8:30 PM | | | | | 118 | 2:30 PM | | | | | | |
| | | | | | | 381 | 8:30 PM | | | | | | |
| | | | | | | 166 | 10:30 PM | | | | | | |

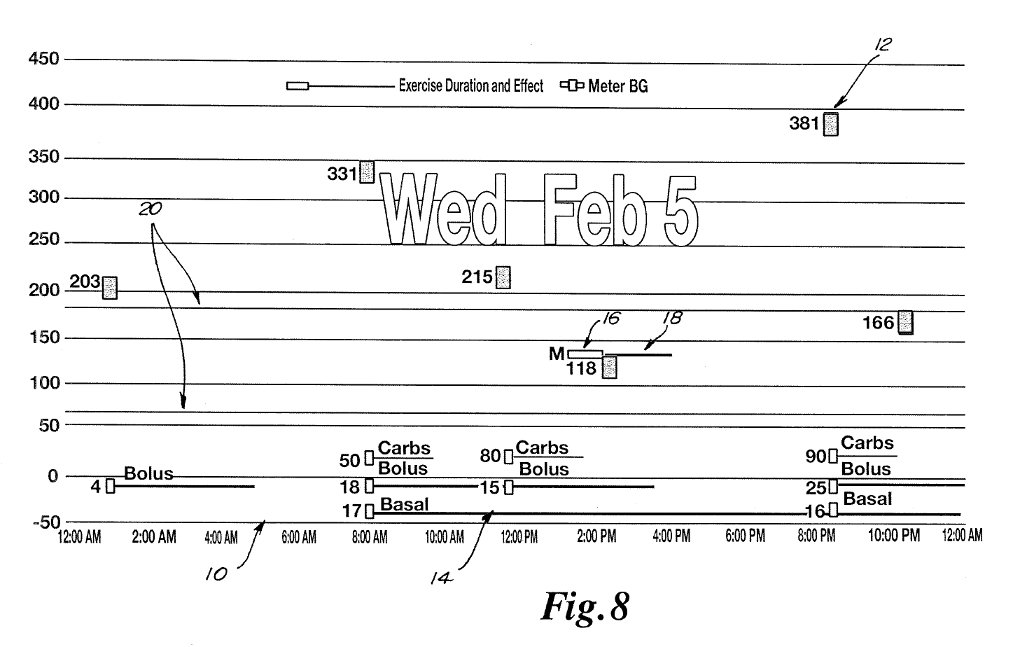

A first representation of a relationship graph from the data in Table 1 is depicted in FIG. 8.

The bottom line 10 represents the date and time line. The small squares 12 represent the blood glucose measurement. The horizontal lines 14 (pigtails) associated with carbs, bolus and basal medication doses represent the time of effectiveness, which is assumed to be linear. This shows the relationship to the blood glucose readings. The dots represent the time administered. Exercise duration is shown as an extended dot 16 of uniform thickness. The effect of exercise is shown as an extended line 18 (a pigtail) of different thickness. The dotted horizontal lines 20 represent the target range for blood glucose readings.

This patent application does not cover the calculation of the length of the pigtails but possible settings are, without limitation, as follows. All of these parameters and others may be used to set the pigtail values.

Bolus medication—4 hours.

Basal medication—24 hoursCarbohydrates—2 hours after last ingestion.

Exercise—light/moderate/intense/strenuous Light—pig tail equal to duration:

Moderate—pigtail equal to 2 times duration Intense—pigtail equal to 4 times duration Strenuous—pigtail equal to 6 times duration.

The time duration of rapid and long acting insulin is published, as part of the FDA required documentation for approval.

Mealtime digestion range is 2-4 hours, excluding extenuation due to “re-feeding.” In adults, the development of autonomic gastroparesis leads to delayed gastric emptying. The literature states that it can cause continued emptying after 4 hours but the endpoint is not defined. The consistent “all done” criteria is 4 hours. Normal individuals will digest a meal in 2 hours. High fat content in a meal is known to “delay” gastric emptying. This is well described for “pizza” that allows for around 50% of the carbohydrate to be absorbed in 2 hours and the rest in another 2 hours that usually begins at +3 hours from starting the ingestion of food.

Impact of exercise varies with individuals but some published articles provide general suggestions. See, e.g., “Insulin dose adjustment and exercise in type 1 diabetes: what do we tell the patient,” Alistair N. Lumb and Ian W. Gallen, The British Journal of Diabetes and Vascular Disease, Vol. 9, No. 6, November/December 2009; “Glucose Requirements to Maintain Euglycemia after Moderate-Intensity Afternoon Exercise in Adolescents with Type 1 Diabetes are Increased in a Biphasic Manner,” Sarah K. McMahon et. al., The Journal of Clinical Endocrinology & Metabolism 92(3) 963-968, March 2007.

The effect of stress and illness is quite variable. This will be displayed at the discretion of the PWD: infectious diseases, medical intervention with drugs known to antagonize the effect of insulin [e.g. prednisone, albuterol, etc], menstrual cycle events, surgery, anesthesia, etc.

### Experiment #2

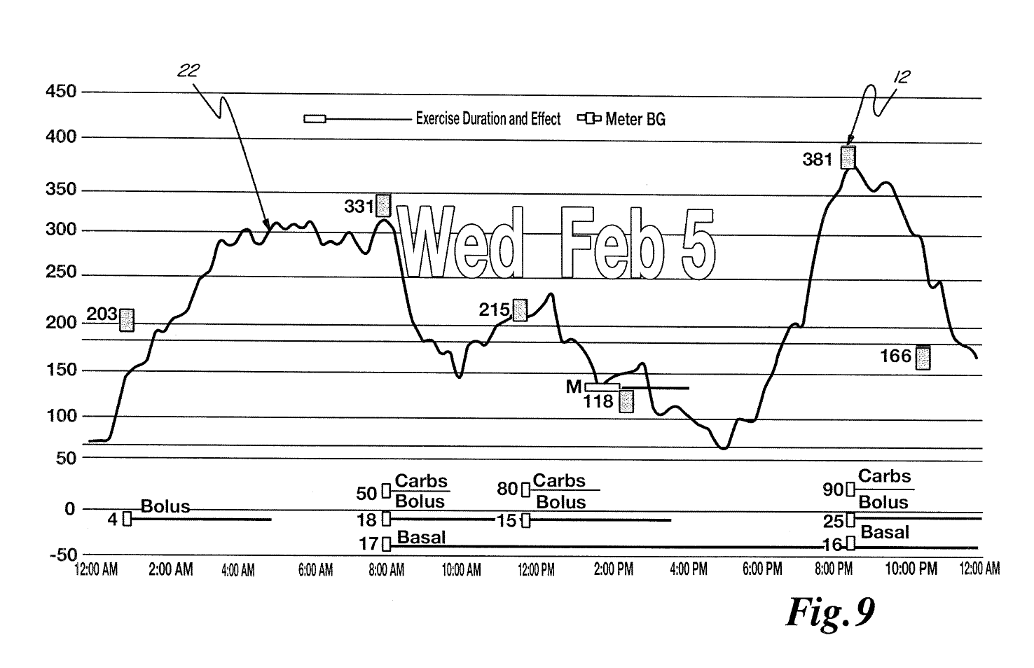

Blood glucose readings were taken continuously using a Medtronic Solutions Continuous Glucose Monitoring System (CGMS) iPro Model 2.0A. Finger pricks were taken at discrete intervals to calibrate the CGMS. FIG. 9 shows a representation of a relationship graph from the results.

The small squares 12 represent these discrete calibration measurements. Output 22 from the CGMS is overlaid on the graph. The data for carbs, bolus insulin, and basal insulin is the same as in Table 1. The patient exercised moderately for the duration shown in Table 1.

Table 2 shows the values of blood glucose from the CGMS.

TABLE 2
Continuous Glucose Data

| 12:15 AM | 12:30 AM | 12:45 AM | 1:00 AM | 1:15 AM | 1:30 AM | 1:45 AM | 2:00 AM |
|---|---|---|---|---|---|---|---|
| 72 | 73 | 105 | 139 | 150 | 157 | 185 | 187 |
| 2:15 AM | 2:30 AM | 2:45 AM | 3:00 PM | 3:15 AM | 3:30 AM | 3:45 AM | 4:00 AM |
| 200 | 205 | 217 | 242 | 252 | 282 | 278 | 285 |
| 4:15 AM | 4:30 AM | 4:45 AM | 5:00 AM | 5:15 AM | 5:30 AM | 5:45 AM | 6:00 AM |
| 295 | 278 | 285 | 300 | 295 | 298 | 295 | 300 |
| 6:15 AM | 6:30 AM | 6:45 AM | 7:00 AM | 7:15 AM | 7:30 AM | 7:45 AM | 8:00 AM |
| 281 | 280 | 280 | 292 | 278 | 272 | 300 | 303 |
| 8:15 AM | 8:30 AM | 8:45 AM | 9:00 AM | 9:15 AM | 9:30 AM | 9:45 AM | 10:00 AM |
| 295 | 250 | 200 | 180 | 178 | 165 | 165 | 140 |
| 10:15 AM | 10:30 AM | 10:45 AM | 11:00 AM | 11:15 AM | 11:30 AM | 11:45 AM | 12:00 PM |
| 174 | 178 | 175 | 195 | 200 | 205 | 203 | 207 |
| 12:15 PM | 12:30 PM | 12:45 PM | 1:00 PM | 1:15 PM | 1:30 PM | 1:45 PM | 2:00 PM |
| 215 | 229 | 182 | 180 | 175 | 162 | 135 | 140 |
| 2:15 PM | 2:30 PM | 2:45 PM | 3:00 PM | 3:15 PM | 3:30 PM | 3:45 PM | 4:00 PM |
| 145 | 146 | 150 | 155 | 110 | 104 | 110 | 107 |
| 4:15 PM | 4:30 PM | 4:45 PM | 5:00 PM | 5:15 PM | 5:30 PM | 5:45 PM | 6:00 PM |
| 100 | 90 | 85 | 70 | 70 | 98 | 98 | 100 |
| 6:15 PM | 6:30 PM | 6:45 PM | 7:00 PM | 7:15 PM | 7:30 PM | 7:45 PM | 8:00 PM |
| 132 | 150 | 182 | 199 | 200 | 252 | 301 | 330 |
| 8:15 PM | 8:30 PM | 8:45 PM | 9:00 PM | 9:15 PM | 9:30 PM | 9:45 PM | 10:00 PM |
| 345 | 365 | 365 | 345 | 340 | 349 | 340 | 315 |
| 10:15 PM | 10:30 PM | 10:45 PM | 11:00 PM | 11:15 PM | 11:30 PM | 11:45 PM | 12:00 AM |
| 295 | 291 | 240 | 242 | 199 | 180 | 177 | 165 |

### Experiment #3

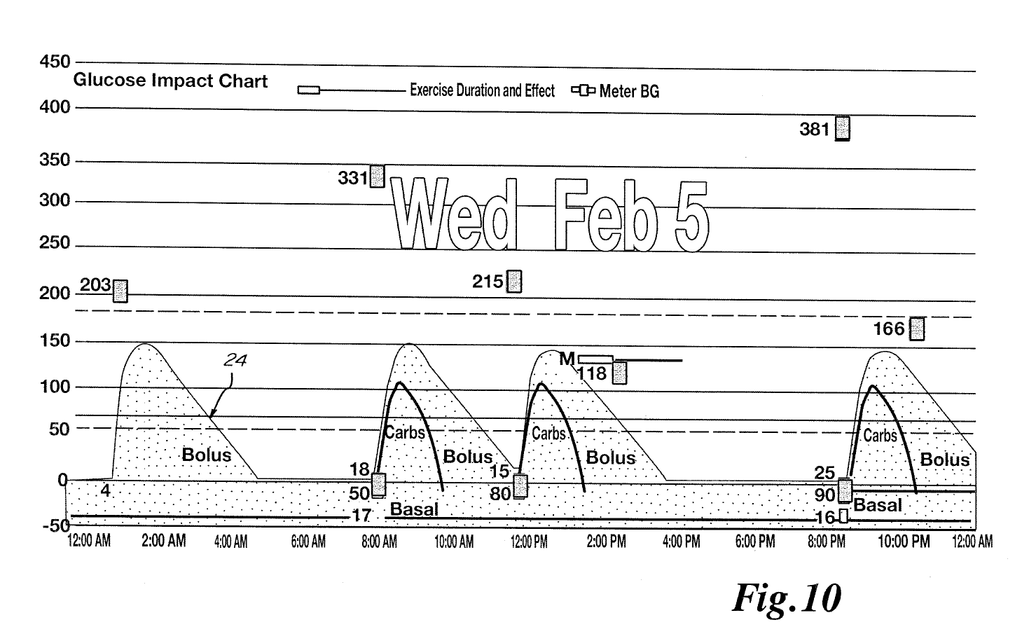

Blood glucose readings were taken at discrete intervals (e.g., by finger pricks). Carbohydrates, bolus insulin, and basal insulin were administered at the times shown in Table 1. The patient exercised moderately for the duration shown in Table 1. FIG. 10 shows a representation of a relationship graph from the results. Unlike Experiments 1 and 2, the time of administration and duration of effect of carbohydrates and bolus insulin is calculated from generally accepted parameters and shown 24 as variable over time. The amount of carbohydrates, bolus insulin, and basal insulin is the same as Table 1.

### Experiment #4

Blood glucose readings were taken continuously using a Medtronic Solutions Continous Glucose Monitoring System (CGMS) iPro Model 2.0A. Finger pricks were taken at discrete intervals to calibrate the CGMS. The small squares represent these discrete calibration measurements. Output from the CGMS is overlaid on the graph. Unlike Experiments 1 and 2, the time of administration and duration of effect of carbs and bolus insulin is calculated from generally accepted parameters and shown as variable over time. The amount of carbohydrates, bolus insulin, and basal insulin is the same as Table 1. The patient exercised moderately for the duration shown in Table 1.

Table 3 shows the values of blood glucose from the CGMS.

TABLE 3
Continuous Glucose Data

| 12:15 AM | 12:30 AM | 12:45 AM | 1:00 AM | 1:15 AM | 1:30 AM | 1:45 AM | 2:00 AM |
|---|---|---|---|---|---|---|---|
| 72 | 73 | 105 | 139 | 150 | 157 | 185 | 187 |
| 2:15 AM | 2:30 AM | 2:45 AM | 3:00 PM | 3:15 AM | 3:30 AM | 3:45 AM | 4:00 AM |
| 200 | 205 | 217 | 242 | 252 | 282 | 278 | 285 |
| 4:15 AM | 4:30 AM | 4:45 AM | 5:00 AM | 5:15 AM | 5:30 AM | 5:45 AM | 6:00 AM |
| 295 | 278 | 285 | 300 | 295 | 298 | 295 | 300 |
| 6:15 AM | 6:30 AM | 6:45 AM | 7:00 AM | 7:15 AM | 7:30 AM | 7:45 AM | 8:00 AM |
| 281 | 280 | 280 | 292 | 278 | 272 | 300 | 303 |
| 8:15 AM | 8:30 AM | 8:45 AM | 9:00 AM | 9:15 AM | 9:30 AM | 9:45 AM | 10:00 AM |
| 295 | 250 | 200 | 180 | 178 | 165 | 165 | 140 |
| 10:15 AM | 10:30 AM | 10:45 AM | 11:00 AM | 11:15 AM | 11:30 AM | 11:45 AM | 12:00 PM |
| 174 | 178 | 175 | 195 | 200 | 205 | 203 | 207 |
| 12:15 PM | 12:30 PM | 12:45 PM | 1:00 PM | 1:15 PM | 1:30 PM | 1:45 PM | 2:00 PM |
| 215 | 229 | 182 | 180 | 175 | 162 | 135 | 140 |
| 2:15 PM | 2:30 PM | 2:45 PM | 3:00 PM | 3:15 PM | 3:30 PM | 3:45 PM | 4:00 PM |
| 145 | 146 | 150 | 155 | 110 | 104 | 110 | 107 |
| 4:15 PM | 4:30 PM | 4:45 PM | 5:00 PM | 5:15 PM | 5:30 PM | 5:45 PM | 6:00 PM |
| 100 | 90 | 85 | 70 | 70 | 98 | 98 | 100 |
| 6:15 PM | 6:30 PM | 6:45 PM | 7:00 PM | 7:15 PM | 7:30 PM | 7:45 PM | 8:00 PM |
| 132 | 150 | 182 | 199 | 200 | 252 | 301 | 330 |
| 8:15 PM | 8:30 PM | 8:45 PM | 9:00 PM | 9:15 PM | 9:30 PM | 9:45 PM | 10:00 PM |
| 345 | 365 | 365 | 345 | 340 | 349 | 340 | 315 |
| 10:15 PM | 10:30 PM | 10:45 PM | 11:00 PM | 11:15 PM | 11:30 PM | 11:45 PM | 12:00 AM |
| 295 | 291 | 240 | 242 | 199 | 180 | 177 | 165 |

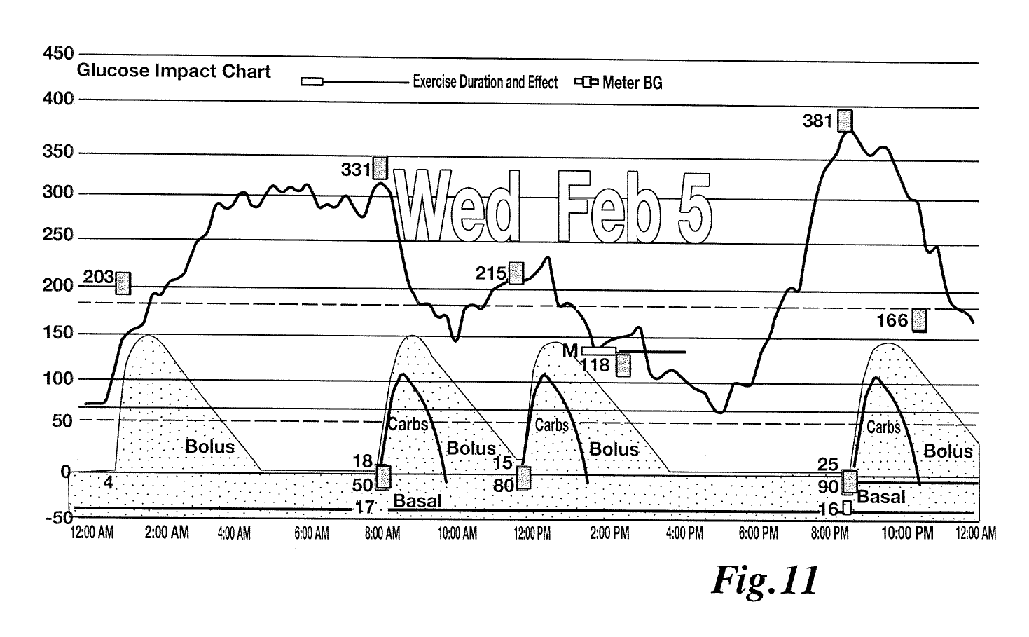

FIG. 11 shows a representation of a relationship graph from the results.

### Prospective Experiment

In order to compare FIGS. 9-11, which are based on data from a patient, with normal data, a prospective experiment was carried out. Blood glucose readings, carbohydrates, exercise, basal insulin, and bolus insulin values were set to show what a graphic would look like in the case of a patient whose blood glucose readings are optimal with respect to the other parameters.

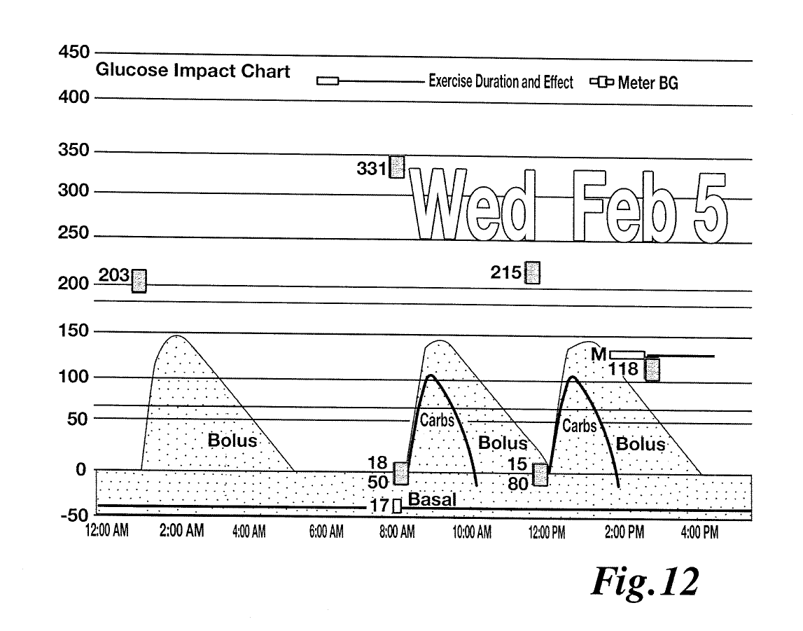

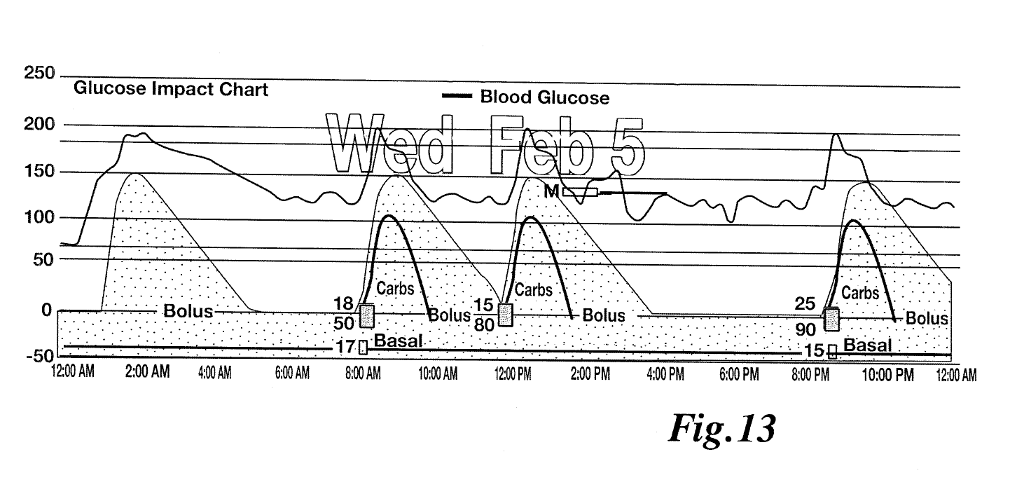

FIGS. 12 and 13 show the result.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. An easy-to-use, real-time system to systematically support personal reporting, tracking, monitoring, documenting and visualizing personal management and outcomes patterns, capable of executing on a computer, capable of receiving data input through an input device from a user on the time of day of one or more blood glucose level measurements of the user's blood and the time of day one or more events affecting the blood glucose level of the user, capable of processing the data, and capable of outputting results to the user on an output device, the system comprising a processor, memory, the input device, and the output device, wherein the results capable of being outputted to the user on the output device further comprise a graph with a first axis indicating the time of day of the blood glucose level measurement and a second axis indicating the one or more measured blood glucose levels, and wherein the events, duration of each event, and the duration of the effect of each event on the user's blood glucose level are capable of being overlaid on the graph on the output device.

2. The system of claim 1, capable of measuring the blood glucose level at discrete points.

3. The system of claim 1, capable of measuring the blood glucose level continuously by a continuous glucose monitoring apparatus.

4. The system of claim 2, wherein the durations of the effects of the events are capable of being shown as linear over time.

5. The system of claim 2, wherein the duration of the effects of the events are capable of being shown as varying over time.

6. The system of claim 3, wherein the duration of the effects of the events are capable of being shown as linear over time.

7. The system of claim 3, wherein the duration of the effects of the events are capable of being shown as varying over time.

8. A mobile device for the management of diabetes, said device further comprising a memory, a processor, an input device, an output device, and a computer program executing on the processor, the computer program further comprising a settings module, a glucose module, and a patterns module, and the glucose module configured to receive blood glucose measurement data input from a user through the input device, the patterns module configured to analyze the blood glucose measurement data in real time and to output results of the analysis of blood glucose measurement data to the user on the output device, wherein the results outputted to the user further comprise a graph with a first axis indicating time of day and a second axis indicating the measured blood glucose level, and wherein time of administration and duration of events affecting the blood glucose level and duration of effect of the events are overlaid on the graph.

9. The mobile device of claim 8, wherein the blood glucose level is measured at discrete points.

10. The mobile device of claim 8, wherein the blood glucose level is measured continuously by a continuous glucose monitoring apparatus.

11. The mobile device of claim 9, wherein the duration of effect of the events is shown as linear over time.

12. The mobile device of claim 9, wherein the duration of effect of the events is shown as varying over time.

13. The mobile device of claim 10, wherein the duration of effect of the events is shown as linear over time.

14. The mobile device of claim 10, wherein the duration of effect of the events is shown as varying over time.

15. The mobile device of claim 8, wherein an event further comprising stress or illness is capable of being overlaid on the graph, wherein the duration of effect is between three and fourteen days.

16. A computer-readable memory comprising an application program executable by a computer having a central processing unit, an input device, and an output device, the computer-readable memory configured to:
(a) receive data input through the input device from a user on the time of day of one or more blood glucose level measurements of the user's blood and the time of day and duration of one or more events affecting the user's blood glucose level;
(b) process the data; and
(c) output the results of the processing to the user on the output device;
(d) wherein the results outputted to the user on the output device comprise a graph further comprising a first axis indicating the time of day of the blood glucose level measurement and a second axis indicating the one or more measured blood glucose levels, and wherein the events, the duration of each event and the duration of the effect of each event on the user's blood glucose level are overlaid on the graph on the output device.

17. The computer-readable memory of claim 16, wherein the events further comprise the occurrence of stress or illness.

18. A computer-based method for the management of diabetes, receiving data input from a user through an input device, processing the data, and outputting results to the user on an output device, comprising the steps of:
(a) inputting a target glucose range of the user;
(b) inputting a blood glucose measurement of the user;
(c) inputting an event associated with the glucose measurement; and
(d) outputting information to the user, wherein the information outputted to the user further comprises a graph with a first axis indicating time of day and a second axis indicating the measured blood glucose level, and wherein time of administration, duration, and duration of effect of the event are overlaid on the graph.

19. The method of claim 18, wherein the blood glucose level is measured at discrete points.

20. The method of claim 18, wherein the blood glucose level is measured continuously by a continuous glucose monitoring apparatus.

21. The method of claim 19, wherein the duration of effect of the event is shown as linear over time.

22. The method of claim 19, wherein the duration of effect of the event is shown as varying over time.

23. The method of claim 20, wherein the duration of effect of the event is shown as linear over time.

24. The method of claim 20, wherein the duration of effect the event is shown as varying over time.

25. The system of claim 1, wherein the events are selected from the group consisting of: carbohydrate intake, exercise, administering basal insulin, and administering bolus insulin

26. The mobile device of claim 8, wherein the events are selected from the group consisting of: consuming carbohydrates, exercising, administering basal insulin, and administering bolus insulin.

27. The computer-readable memory of claim 16, wherein the events further comprise carbohydrate intake, exercise, administering basal insulin, and administering bolus insulin.

28. The method of claim 18, wherein the events further comprise carbohydrate intake, exercise, administering basal insulin, and administering bolus insulin.
